(19) United States
(12) Patent Application Publication
(10) Pub. No.: US 2002/0072942 A1
(43) Pub. Date: Jun. 13, 2002

(54) System and method for push-model fund transfers

(76) Inventors: James B. Kuykendall, Newport Beach, CA (US); Thomas G. Cleveland JR., Newport Beach, CA (US)

Correspondence Address: Woodard, Emhardt, Naughton, Moriarty and McNett, Bank One Center/Tower, Suite 3700, 111 Monument Circle, Indianapolis, IN, 46204-5137, US

(21) Appl. No.: 09/929,460

(22) Filed: Aug. 14, 2001

Related U.S. Application Data
(60) Provisional application No. 60/251,939, filed on Dec. 7, 2000.

(51) Int. Cl. G06F 17/60

(52) U.S. Cl. 705/7

(57) ABSTRACT

A system for performing push-model fund transfers between at least one user and at least one payor comprises: at least one payor interface and a gateway having at least one gateway account. The gateway is operative to receive information from said payor interface identifying a desired fund transfer; to receive incoming funds from the payor into said at least one gateway account after receiving said information; to informing the user that the payor has provided an appropriate amount of funds if said incoming funds received are of an appropriate amount according to said desired fund transfer; and to send corresponding outgoing funds to the user after receiving said incoming funds.

### BACKGROUND

E-commerce-generated transactions are a growing part of the economy. In particular, e-commerce is making it increasingly feasible to perform international transactions. Consequently, e-commerce provides existing businesses with the opportunity for growth through expansion of their markets overseas. Likewise, new businesses that were not previously feasible can successfully enter the marketplace due to the growing ability to reach a wider potential pool of customers.

Today, e-commerce-generated transactions consist primarily of credit card payments. E-commerce transactions are obtained by merchants, their acquirers, or from Internet sessions and voice communications lines. In the virtual world, the point of sale (POS) device is no longer an in-store terminal where cards or checks are swiped, authorized by an issuer/authorization service, and then authorized by signature of the payor. Today, the POS device is a computer, phone, or personal communication device that sends and receives point of sale data. Since these are remote transactions, there must be steps to authenticate the parties to the transaction as well as authorize the payment itself.

Remote credit card transactions are more expensive for the merchant because the merchant suffers a higher risk of fraud than traditional brick and mortar transactions. Merchants pay a higher rate to have the issuer authorize such transactions, but still incur higher rates of charge-backs and fraudulent transactions. In order to absorb the high rate of charge-backs and fraud, merchants must add these costs as a percentage of sales prices in order to accommodate remote transactions.

While credit card payments dominate e-commerce and other remote transactions, other payment options do exist. However, other alternatives are primarily based on debit, or “pull,” models. Electronic check is one such option that has been gaining in popularity. E-commerce and the experience with credit cards has generated interest in other options, due to initiatives such as point of sale check conversion, real time access from the point of sale, and the evolution of checking accounts to exploit the ATM network. Most of these electronic check debits are ACH transactions. Although they are low cost batch-processed payments, they also have unique problems that make them uncertain and expensive. These problems include the need for authentication, so that an electronic signature can be acquired to authorize the debit to the payor's account, the danger of rescission, and the complexity of processing.

The danger of rescission arises from the fact that debits can be returned within 60 days by the consumer as unauthorized. Returns can also occur due to insufficient funds (“NSF”), closed accounts, incorrect account information (including those arising from transcription errors), and stop pay orders.

The complexity of processing is complicated by the fact that information on checks does not always accurately indicate how they should be processed electronically. This problem is exacerbated in the context of remote transactions, in which it is more difficult to supplement information that turns out to be insufficient.

The consequence of these undesirable attributes of electronic check debiting is confusion, high costs, and, most importantly, a lack of good funds. The growth of the Internet and the exploding e-commerce market, consumers, merchants, and their providers are looking for a payment mechanism that presents an assured and less expensive alternative.

Therefore, a system and method for remote fund transfers that is simpler, faster, less expensive than electronic checks, and that results in good funds is needed. In particular, an improved method for remote transfers across national boundaries is needed. The present invention is directed towards meeting these needs, among others.

### SUMMARY OF THE INVENTION

A first embodiment system for performing push-model fund transfers between at least one user and at least one payor comprising: at least one payor interface and a gateway having at least one gateway account. The gateway is operative: to receive information from said payor interface identifying a desired fund transfer; to receive incoming funds from the payor into said at least one gateway account after receiving said information; to informing the user that the payor has provided an appropriate amount of funds if said incoming funds received are of an appropriate amount according to said desired fund transfer; and to send corresponding outgoing funds to the user after receiving said incoming funds.

A second embodiment system for performing push-model fund transfers between a plurality of merchants and at least one payor, the system comprising: at least one merchant website and a gateway. The gateway comprises a gateway bank, said gateway bank having at least one gateway account. The gateway is operative to permit the at least one payor to provide information identifying a desired fund transfer, including the payor, a payee-merchant, and an amount of funds to be transferred; to receive said information from said at least one merchant website; to calculate an appropriate amount of incoming funds corresponding to said amount of funds to be transferred; to provide deposit information to the at least one payor sufficiently identifying said gateway account to permit the payor to cause said appropriate amount of incoming funds to be deposited in said at least one gateway account; to receive incoming funds from the payor into said at least one gateway account after receiving said information; to informing the payee-merchant that the payor has provided said appropriate amount of incoming funds if said incoming funds received are of said appropriate amount of incoming funds; and to send outgoing funds in said amount of funds to be transferred to the payee-merchant after receiving said incoming funds.

A third embodiment system for transferring funds from a source of funds to a domestic student having a student's account comprises: a gateway having at least one domestic gateway account; at least one foreign account; and a gateway interface. The foreign account is operative to receive incoming funds from the source of funds in a first currency, and to inform said gateway of a first quantity of said incoming funds after said incoming funds have been received. The gateway interface is operative to permit the student to request a fund transfer through said gateway by identifying the student's account, the source of funds, and a desired quantity of funds to be transferred. The gateway transfers a corresponding second quantity of funds in said first currency from said gateway account to the student account in a second currency after being informed of said first quantity.

A fourth embodiment system for transferring funds from a plurality of sources of funds, each source of funds being in a corresponding foreign country, to a plurality of students in the United States, each student having a student's account comprises: a gateway; at least one correspondent bank; and a website. The gateway comprises a federally insured gateway bank, the gateway bank including at least one gateway account in the United States. The at least one correspondent bank provides at least one foreign account in each of the corresponding foreign countries, the at least one foreign account being operative to receive incoming funds in a first currency and from at least one source of funds, and to inform said gateway of a first quantity of said incoming funds after said incoming funds have been received. The website is operative to permit the students to request fund transfers through said gateway, each of said fund transfers being requested by one of the students by identifying the student's account, the student's source of funds, and a desired quantity of funds to be transferred. The gateway transfers a corresponding second quantity of funds in said first currency from said gateway account to the student account in a second currency after being informed of said first quantity. The at least one correspondent bank exchanges funds in foreign currencies for U.S. dollars after sufficient incoming funds have accumulated to permit the at least one correspondent bank to receive a superior rate of exchange and transfers the U.S. dollars to the gateway bank.

A fifth embodiment system for performing push-model fund transfers is in communication with the Internet and comprises: a customer front end; a customer service front-end; a treasury front-end; an OFAC filter; an FX engine; a transfer engine; and a risk management module. The customer front-end is adapted to enable a customer to enroll in the system, to request a fund transfer, and to observe information regarding the fund transfer, the customer front end also being adapted to generate and to transmit a transaction corresponding to the fund transfer. The customer service front-end is adapted to enable system operators to observe information regarding the fund transfer. The operations front-end is adapted to enable a system operator to observe information regarding ACH settlements and returns (or transfers via the ATM network or other transfer mechanisms). The treasury front-end is adapted to enable a treasury operator to update currency conversion rates, customer fees, adjust risk parameters, and correspondent bank account numbers. The OFAC filter is adapted to download and import and OFAC database from the Internet into the system. The FX engine comprises: an FX transaction database; a user database; an acquiring system; and FX XML agent; an e-mail agent; a plurality of front-end servers; and a currency manager. The acquiring system is adapted to accept the transaction request from the customer front en, to perform an OFAC check on the accepted transaction request using the OFAC database downloaded by the OFAC filter, and to store a transaction record in the FX transaction database if the OFAC check on the transaction request is passed, the transaction record containing information regarding a transaction. The FX XML agent is adapted to read a transaction record from the FX transaction database, to create a corresponding XML file, and to send the corresponding XML file to the ACH engine. The e-mail agent is adapted to send an e-mail message to a customer when the customer enrolls in the system, when a transaction is requested, and when a transaction is confirmed. The plurality of front-end servers each comprise: an event server; a user server; a transaction ID server; and a signing server. The event server is adapted to pass a status of a transaction. The user server is adapted to pass information regarding an enrollment. The transaction ID server is adapted to generate a unique number for each transaction. The signing server is adapted to perform a security check on each transaction. The currency manager comprises: a rate server, adapted to read the currency exchange rate from the FX database; and a rate agent, adapted to pass information from the treasury front-end. The transfer engine comprises: a transfer processor; and a transfer database. The transfer processor is adapted to read a directory of new files from the FX engine, to write a new file corresponding to the transaction to the transfer database, to process the new file to create a transaction file, and to send the transaction file to the Visa interface. The risk management module is adapted to use the risk parameters to impose velocity limits on requests for fund transfers.

### BRIEF DESCRIPTION OF THE DRAWINGS

FIG. 1a is a block diagram of a first embodiment system for push-model fund transfers.

FIG. 1b is a block diagram of a second embodiment system for push-model fund transfers.

FIG. 2 is a block diagram of system for efficient international fund transfers to a student from a source of funds, such as a parent or other family member.

FIG. 3 is a block diagram showing additional details of the system of FIG. 2.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Such alterations and further modifications in the illustrated device, and such further applications of the principles of the invention as illustrated therein as would normally occur to one skilled in the art to which the invention relates are contemplated by the present invention.

A push-model system for fund transfers according to the present invention permits merchants to be certain of compensation much faster than is possible when payment is made using other payment mechanisms, such as credit card payments or electronic checks. With “pulled” transactions (e.g. transactions initiated by a debit generated by the merchant and submitted, for example, through the ACH system to the purchaser's account), the merchant may not be compensated for one of many reasons. For example, the account the purchaser identifies for payment may not have sufficient funds. Even if there are sufficient funds at the time of the purchase, they may be withdrawn from the account prior to settlement. And, even if sufficient funds are present and they are transferred during the settlement, under ACH rules, for example, the purchaser has up to 60 days in which he or she may reverse the transfer. Likewise, with an online credit card payment, the customer may reverse the transaction many days after the purchase. Unlike face-to-face credit card transactions, when the customer refuses to pay for a remote transaction, or reverses or rescinds a remote transaction, the credit-card company does not compensate the merchant. With pull-model payment mechanisms, therefore, the merchant must choose whether to wait for as long as 60 days to ship the goods or provide the services, or to incorporate into its prices the cost of a fraction of transactions for which it will not be compensated.

In addition to potentially faster service, lower prices, and guaranteed funds a preferred embodiment push-model system according to the present invention can benefit purchasers with improved privacy and security. Because the fund transfer is initiated by an order to pay made directly to the purchaser's bank, there is no need to provide information about his or her account to the merchant. Likewise, information necessary for authentication, such as a password or PIN number, can be passed directly from the purchaser to his or her bank.

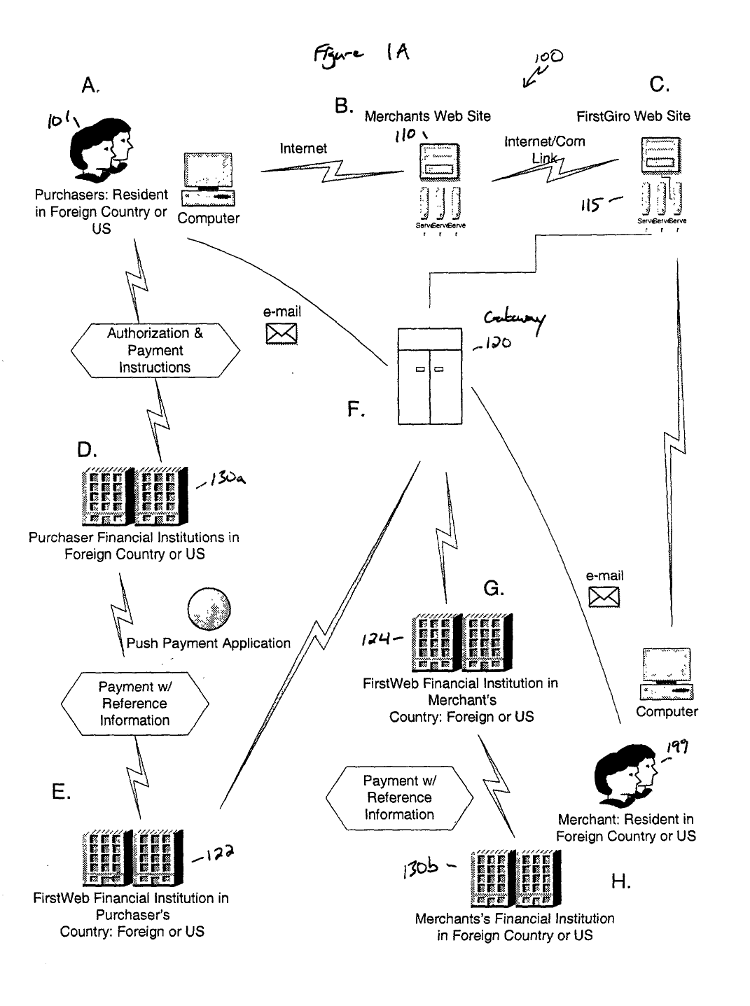

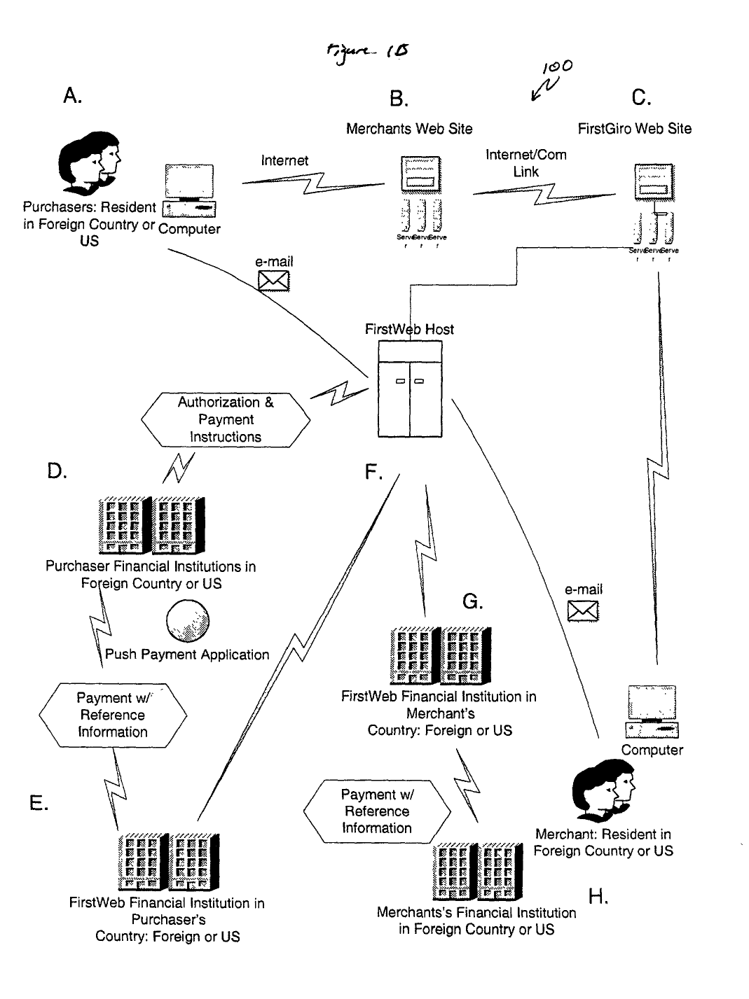

FIGS. 1A and 1B illustrates certain elements of a system for push-model fund transfers according to the present invention, indicated generally as 100. Referring to FIG. 1A, the system 100 facilitates transactions between a purchaser 101 and a merchant 199. The system 100 includes a merchant's website 110, a gateway 120, and at least one financial institution 130. The merchant's website 110 includes software operative to connect a user with the gateway 120. The gateway 120 includes software operative to permit a user to generate an order to pay and to submit that order to at least one financial institution 130. The gateway 120 also includes software operative to connect a user directly with the at least one financial institution 130 such that the user can authenticate an order to pay. In the preferred embodiment, the gateway further includes a gateway bank 122 that is used to receive payment from the at least one financial institution 130. Preferably, the system 100 further includes one or more gateway correspondent banks 124, as discussed further herein.

In the preferred embodiment, a merchant 199 can choose to offer the system 100 to its customers as a payment mechanism by enrolling with the gateway 120. The gateway 120 then provides the software to the merchant 199 to incorporate into a merchant's website 110. The software can either be provided in the form of an independent application, or in the form of a hyperlink to a hub (or website) 115 maintained by the gateway 120. FIGS. 1A and 1B illustrate the situation in which the software is provided in the form of a hyperlink to a website 115.

A purchaser 101 having an account with a purchaser's financial institution 130a that is one of the at least one financial institution 130 accesses the system 100 by accessing a merchant's website 110, for example via the Internet. When the purchaser 101 purchases goods or services from the merchant 199, and selects the system 100 as his or her preferred option for payment, the merchant's website 110 preferably provides the purchaser 101 with all necessary information about how the system 100 functions. The merchant website 110 then connects the purchaser 101 with the gateway 120. In certain alternative embodiments, the gateway 120 provides necessary information to the purchaser 101 about how the system 100 functions.

In certain embodiments, the gateway 120 connects the purchaser 101, in turn, with the purchaser's financial institution 130a, as shown in FIG. 1B. The gateway 120 provides the purchaser 101 with the interface to create a credit transfer to the gateway bank 122 from the purchaser's financial institution 130a, and to connect directly with the purchaser's financial institution 130a. Once in contact with the purchaser's financial institution 130a, the purchaser 101 provides the appropriate authentication directly to the financial institution 130a. FIG. 1A illustrates certain other embodiments, in which the gateway 120 relays information to the purchaser 101 that enables purchaser 101 to independently effect a transfer from the purchaser's financial institution 130a o the gateway bank 122.

Once the gateway bank 122 has received the currency from the purchaser's financial institution 130a, the gateway 120 then directs the gateway bank 122 to transfer the currency to the merchant's financial institution 130b. The gateway 120 also informs the merchant 199 that the currency has been received by the gateway bank 122, so that the merchant 199 can send the goods or provide the services that the purchaser 101 purchased without fear of a charge-back, insufficient funds, fraud, or other reasons for not receiving (and retaining) the agreed compensation.

In the preferred embodiment, the purchaser 101 and merchant 199 need not be located within the same country. In certain embodiments, the system 100 also includes a gateway correspondent bank 124 located in each country in which an enrolled merchant 199 has a merchant's financial institution 130b. In these embodiments, the purchaser 101 instructs the purchaser's financial institution 130a to pay the gateway bank 122 in their common country, and the gateway bank 122 informs the gateway when the funds have been received. The gateway 120 then instructs the correspondent bank 124 to pay the merchant 199. The correspondent bank 124 can receive the funds from the gateway bank 122 at a later time. Note that it is possible for the purchaser's financial institution 130a to be the correspondent bank 124. In this case, the correspondent bank 124 simply informs the gateway 120 when the order to pay is received. It should also be noted that the gateway 120 can be located in either the purchaser's 101 country or the merchant's 199 country, or some other country entirely. The gateway bank 122 and correspondent bank 124 are defined in terms of the location of the purchaser's financial institution 130a and the merchant's financial institution 130b. Therefore, the gateway bank 122 in one transaction can be the correspondent bank 124 in another transaction, and vice versa. Likewise, when the purchaser's financial institution 130a and the merchant's financial institution 130b are located in the same country, the gateway bank 122 and “correspondent” bank 124 can be one and the same.

In these embodiments, the system 100 permits a purchaser 101 in another country to make payments to a domestic merchant 199 substantially faster and less expensively than other international payment mechanisms. Because the gateway 120 can be sure of eventually receiving the funds as soon as they arrive in the gateway bank 122, the gateway can initiate a domestic fund transfer between the correspondent bank 124 and the merchant 199 without having to wait for the funds to be transferred internationally. For the same reason, the international fund transfer can be delayed to permit larger sums to accumulate in the gateway bank 122 and correspondent bank 124, so that larger sums of currency can be converted at one time. The international fund transfers can therefore take advantage of superior exchange rates that are offered for large exchanges, and may be able to exploit fluctuations in the relative values of currencies.

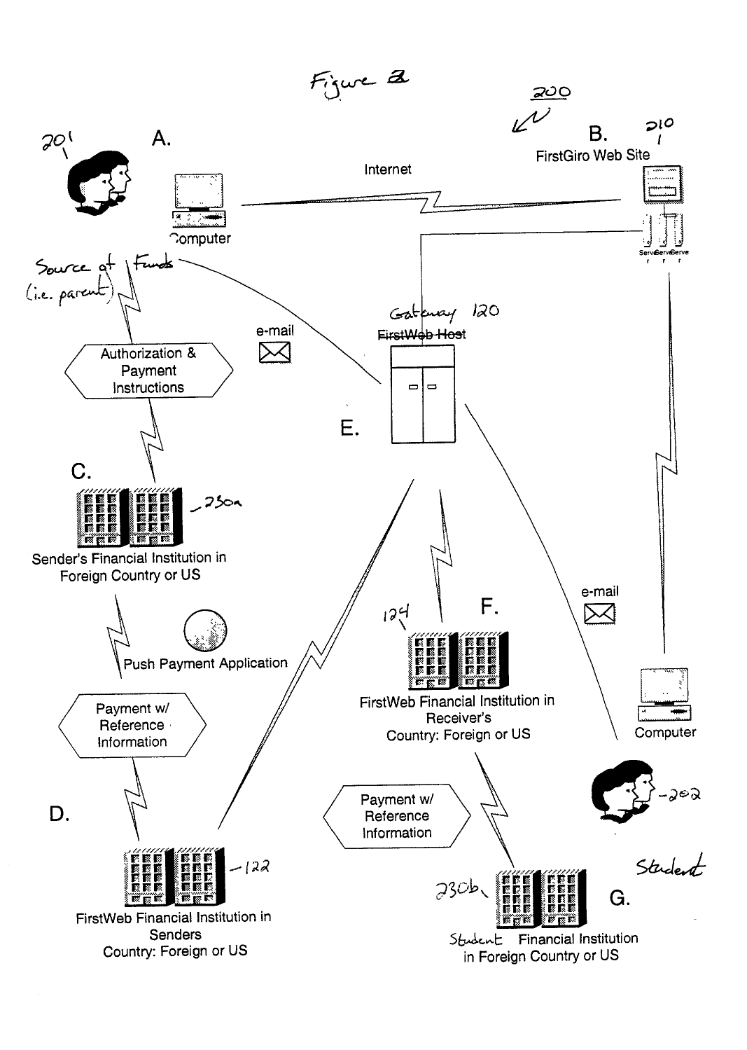

FIG. 2 illustrates certain elements of a system 200 that is particularly adapted to provide fast and efficient transfer of currency to a student in the U.S. (the domestic country) from a source of funds, such as his or her family, living outside of the U.S. (the foreign country). It will be appreciated that the system 200 is equally applicable for any two countries designated as the domestic and the foreign countries. The system 200 comprises a gateway 120 having a gateway website 210 and a gateway bank 122. The gateway website 210 includes software operative to allow a student 202 to identify a student account 230b, and to request a fund transfer to the student account 230b from a source of funds 201. The gateway 120 includes software operative to receive and store information regarding requested fund transfers, and to issue orders to transfer funds from the correspondent bank 124 to designated student accounts 230b. The gateway 120 also includes software operative to compare the student 202 and the source of funds 201 to a list provided by the Office of Foreign Assets Control (“OFAC”) and to reject requested fund transfers that would otherwise violate OFAC directives.

The student 202 accesses the system 200 by accessing the gateway's website 210. Using the gateway's website 210, the student 202 places a request for a fund transfer, identifies his or her student account 230b, and receives information about how the source of funds 201 can transfer foreign currency to a gateway bank 122. The correspondent bank 122 is preferably located in the same country with a source-of-funds' financial institution 230a or with the source of funds 201.

In the presently preferred embodiment, as part of a registration process the gateway 120 directs the correspondent bank 124 to transfer a small amount of domestic currency into the designated student account 230b. Once the student 202 receives the small amount of domestic currency, he or she accesses the gateway's website 210 to verify the exact amount of the deposit, in order to verify to the gateway 120 that the funds have been successfully deposited into the correct account.

In certain embodiments, the gateway sends information directly to the source of funds 201, for example by email, about how to transfer foreign currency to a gateway bank 122. Once this information is provided, by whatever means, the source of funds 201 transfers foreign currency to a gateway bank 122. The source of funds 201 can do this by directing the source-of-funds' financial institution 230a to deposit the appropriate funds, or by directly depositing the funds, or by any other appropriate means. Once the foreign currency has been received by the gateway bank 122, it informs the gateway 120. The gateway 120 then instructs the correspondent bank 124 to transfer a corresponding amount of domestic currency to the designated student account 230b. The gateway 120 also sends information to the student 202 informing him or her that domestic currency is being transferred to the designated student account 230b, and how much is being transferred. The correspondent bank 124 does not need to wait for the funds to be transferred from the gateway bank 122, nor does it have to wait to be sure that the credit to the gateway bank 122 will not be reversed due to a charge-back, insufficient funds, fraud, or other reasons.

Preferably, the gateway 120 provides specific information to the source of funds 201 about the rate of exchange and any fees before the source of funds 201 orders the transaction. In the preferred embodiment, for example, the gateway website 210 permits a user to input either the amount of domestic currency desired to be transferred to the student 202, or the amount of foreign currency desired to be deposited with the gateway bank 122. The gateway website 210 then displays a complete calculation, including the present exchange rate, all associated fees to be charged. The gateway website 210 displays how much foreign currency must be deposited (if the desired amount of domestic currency was input), or how much domestic currency will be delivered (if a desired amount of foreign currency to be deposited was input). In this way, either the student 202 or the source of funds 201 can immediately view all the relevant factors affecting the cost of the transfer, to determine whether the transfer is satisfactory.

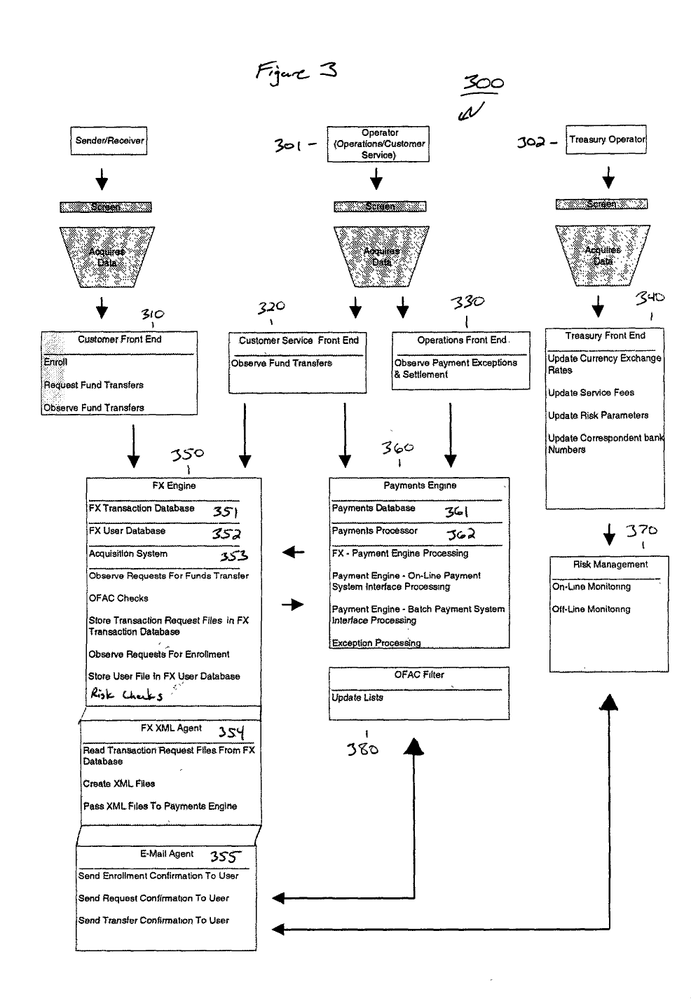

FIG. 3 illustrates further details of software suitable for use in the system 200 for fast and efficient transfer of currency to a student in the U.S. from a source of funds, indicated generally at 300. The system 300 comprises a customer front end 310, a customer-service front end 320, an operations front end 330, a treasury front end 340, an foreign exchange (“FX”) engine 350, an transfer engine 360, a risk management module 370, and an OFAC filter 380.

The customer front end 310 includes software operative to communicate with the FX engine 350. The customer front end 310 includes software operative to permit a student 201 to enroll with the gateway 120 in preparation for future fund transfers, to request fund transfers, and to observe the progress of requested fund transfers by accessing information in the FX engine 350.

The customer-service front end 320 includes software operative to communicate with the FX engine 350 and the transfer engine 360. The customer-service front end 320 includes software operative to permit an operator 301 to observe information regarding requested fund transfers in the FX engine 350 and in the transfer engine 360.

The operations front end 330 includes software operative to communicate with the transfer engine 360, and to permit an operator 301 to observe ACH settlements (or transfers through the ATM network or other transfer mechanisms) and returns through the transfer engine.

The treasury front end 340 includes software operative to permit a treasury operator 302 to update currency exchange rates, to update service fees that are charged for fund transfers, to update risk parameters (stored in the risk management module 370, discussed further hereinbelow), and to update account numbers for correspondent banks 124. The treasury front end 340 is also operative to communicate with the risk management module 370.

The FX engine 350 comprises an FX transaction database 351, an FX user database 352, an acquiring system 353, an FX XML agent 354, and an email agent 355. The acquiring system 353 includes software operative to observe fund transfer requests incoming from the customer front end 310, to compare information in the fund transfer requests with information in the OFAC filter 380 to confirm that the requested fund transfer is permitted by the OFAC, and to pass information regarding the requested transfer to the risk management module 370 to determine if the transaction is presently an acceptable risk to the gateway 120. The acquiring system 353 also includes software operative to store a transaction request file in the FX transaction database 351 if the transaction is permitted by the OFAC and the risk to the gateway 120 is presently acceptable. The acquiring system 353 also includes software operative to store an FX user record in the FX user database 352 after a student 201 successfully enrolls. The FX XML agent 354 includes software operative to read transaction request files from the FX transaction database 351, to create corresponding XML transaction files, and to pass the corresponding XML transaction files to the transfer engine 360. The email agent 355 includes software operative to send an enrollment confirmation email to the student 201 after he or she successfully enrolls, to send a request confirmation email to the student 201 after the acquiring system stores a new fund request file in the FX transaction database, and a transfer confirmation email to the customer 201 when funds requested from the source of funds 202 have been received by the correspondent bank 124.

The transfer engine 360 comprises a transfer database 361 and a transfer processor 362. The transfer processor 362 includes software operative to perform on-line payment systems interface processing (i.e., processing necessary to permit users to select transactions online, and to view the complete calculations showing how much currency will be deposited and how much will be received), to perform batch payment system interface processing (i.e. processing necessary to implement actual fund transfers), and exception processing. Exception processing includes receiving and processing returned ACH transactions.

The risk-management module 370 includes software operative to perform both offline and online risk checks. The online checks are performed in response to a new transaction request and again upon creation of an ACH file for the transaction. Offline checks are performed when the gateway 120 initiates a risk-management report. Both online and offline checks use risk-management parameters provided through the treasury front-end 340.

The OFAC filter 380 includes software operative to periodically access the OFAC, preferably through the OFAC website, to acquire the most recent lists of targeted countries, organizations, and persons, and to provide this information to the FX Engine for OFAC checks on requested transfers.

It will be appreciated that a system and method for push-model fund transfers according to the present invention can be used to transfer funds between any two parties desiring more efficient transaction resulting in guaranteed good funds. For example, such a system and method could be used to transfer payment from an international student to the university itself, in order, for example, to pay tuition.

As another example, such system could be used to transfer funds between a commercial manufacturer in one country and its foreign distributors. Such a system would resemble the one shown in FIG. 1A, with the foreign distributor functioning as the purchaser, while the manufacturer would function as the merchant.

Only the preferred embodiment, and certain alternative embodiments deemed helpful in further illuminating the preferred embodiment, have been shown and described. All changes and modifications that come within the spirit of the invention are desired to be protected. Therefore, while the invention has been illustrated and described in detail in the drawings and foregoing description, they are to be considered as illustrative and not restrictive in character.

What is claimed:

1. A system for performing push-model fund transfers between at least one user and at least one payor, the system comprising:
at least one payor interface comprising software operative to permit the at least one payer to provide information identifying a desired fund transfer;
a gateway having at least one gateway account, said gateway being operative:
to receive said information;
to receive incoming funds from the payor into said at least one gateway account after receiving said information;
to inform the user that the payor has provided an appropriate amount of funds if said incoming funds received are of an appropriate amount according to said desired fund transfer; and
to send corresponding outgoing funds to the user after receiving said incoming funds.

2. The system of claim 1, wherein said software is a website.

3. The system of claim 2, wherein the at least one user is a plurality of merchants, and each merchant has an associated website.

4. The system of claim 1, wherein said gateway comprises a gateway bank, and said gateway account is an element of said gateway bank.

5. The system of claim 1, wherein said information comprises an amount of funds to be transferred, the payor, and the user that is to be a payee of said desired fund transfer.

6. The system of claim 1, wherein said gateway provides deposit information to the at least one payor sufficiently identifying said gateway account to permit the payor to cause funds to be deposited therein.

7. The system of claim 6, wherein the payor must cause funds to be deposited in said gateway account by ordering a financial institution with which the payor has an account to transfer funds into said gateway account.

8. The system of claim 7, wherein the payor orders said financial institution with which the payor has an account to transfer funds into said gateway account using an ACH credit to said gateway account.

9. The system of claim 1, wherein an amount of said corresponding outgoing funds is determined by the payor and the user, and said appropriate amount of said incoming funds is selected by said gateway based on said amount of said corresponding outgoing funds such that said gateway retains some of said incoming funds.

10. A system for performing push-model fund transfers between a plurality of merchants and at least one payor, the system comprising:
at least one merchant website operative to permit the at least one payor to provide information identifying a desired fund transfer, including the payor, a payee-merchant, and an amount of funds to be transferred;
a gateway comprising a gateway bank, said gateway bank having at least one gateway account, said gateway being operative:
to receive said information from said at least one merchant website;
to calculate an appropriate amount of incoming funds corresponding to said amount of funds to be transferred;
to provide deposit information to the at least one payor sufficiently identifying said gateway account to permit the payor to cause said appropriate amount of incoming funds to be deposited in said at least one gateway account;
to receive incoming funds from the payor into said at least one gateway account after receiving said information;
to inform the payee-merchant that the payor has provided said appropriate amount of incoming funds if said incoming funds received are of said appropriate amount of incoming funds; and
to send outgoing funds in said amount of funds to be transferred to the payee-merchant after receiving said incoming funds.

11. A system for transferring funds from a foreign source of funds to a domestic student having a student's account, the system comprising:
a gateway having at least one domestic gateway account;
at least one foreign account operative to receive incoming funds from the source of funds in a first currency, and to inform said gateway of a first quantity of said incoming funds after said incoming funds have been received;
a gateway interface comprising software and operative to permit the student to request a fund transfer through said gateway by identifying the student's account, the source of funds, and a desired quantity of funds to be transferred;
wherein said gateway transfers a corresponding second quantity of funds in said first currency from said gateway account to the student account in a second currency after being informed of said first quantity.

12. The system of claim 11, wherein said gateway comprises a federally insured gateway bank, and said gateway domestic account is an element of said gateway bank.

13. The system of claim 11, wherein said at least one foreign account is an account with a correspondent bank that provides accounts in at least one foreign country.

14. The system of claim 11, wherein said software comprises a website operative to receive as input a desired first quantity and to display a calculation providing the corresponding second quantity, and to receive as input a desired second quantity and to display a calculation providing the corresponding first quantity.

15. The system of claim 11, wherein said domestic account is an account in the United States, and second currency is U.S. dollars.

16. The system of claim 11, wherein said foreign account transfers funds to said gateway account after informing said gateway of said first quantity.

17. The system of claim 16, wherein said foreign account is operative to receive incoming funds from a plurality of sources of funds, and to transfer funds to said gateway account after said incoming funds have accumulated to more than a pre-determined quantity.

18. The system of claim 17, wherein said pre-determined quantity is determined by a quantity necessary to receive a superior rate of exchange between said first and second currencies.

19. A system for transferring funds from a plurality of sources of funds, each source of funds being in a corresponding foreign country, to a plurality of students in the United States, each student having a student's account, the system comprising:
a gateway comprising a federally insured gateway bank, the gateway bank including at least one gateway account in the United States;
at least one correspondent bank providing at least one foreign account in each of the corresponding foreign countries, the at least one foreign account being operative to receive incoming funds in a first currency and from at least one source of funds, and to inform said gateway of a first quantity of said incoming funds after said incoming funds have been received;
a website, operative to permit the students to request fund transfers through said gateway, each of said fund transfers being requested by one of the students by identifying the student's account, the student's source of funds, and a desired quantity of funds to be transferred;
wherein said gateway transfers a corresponding second quantity of funds in said first currency from said gateway account to the student account in a second currency after being informed of said first quantity; and
wherein said at least one correspondent bank exchanges funds in foreign currencies for U.S. dollars after sufficient incoming funds have accumulated to permit the at least one correspondent bank to receive a superior rate of exchange and transfers the U.S. dollars to the gateway bank.

20. A system for performing push-model fund transfers, the system being in communication with the Internet and comprising:
a customer front-end, adapted to enable a customer to enroll in the system, to request a fund transfer, and to observe information regarding the fund transfer, the customer front end also being adapted to generate and to transmit a transaction corresponding to the fund transfer;
a customer service front-end, adapted to enable system operators to observe information regarding the fund transfer;
an operations front-end, adapted to enable a system operator to observe information regarding settlements and returns;
a treasury front-end, adapted to enable a treasury operator to update currency conversion rates, customer fees, adjust risk parameters, and correspondent bank account numbers;
an OFAC filter, adapted to download and import an OFAC database from the Internet into the system;
an FX engine, comprising:
an FX transaction database;
a user database;
an acquiring system, adapted to accept the transaction request from the customer front end, to perform an OFAC check on the accepted transaction request using the OFAC database downloaded by the OFAC filter, and to store a transaction record in the FX transaction database if the OFAC check on the transaction request is passed, the transaction record containing information regarding a transaction;
an FX XML agent, adapted to read a transaction record from the FX transaction database, to create a corresponding XML file, and to send the corresponding XML file to the transfer engine;
an e-mail agent, adapted to send an e-mail message to a customer when the customer enrolls in the system, when a transaction is requested, and when a transaction is confirmed;
a plurality of front-end servers, comprising:
an event server, adapted to pass a status of a transaction;
a user server, adapted to pass information regarding an enrollment;
a transaction ID server, adapted to generate a unique number for each transaction;
a signing server, adapted to perform a security check on each transaction;
a currency manager, comprising:
a rate server, adapted to read the currency exchange rate from the FX database;
a rate agent, adapted to pass information from the treasury front-end;
the FX engine being adapted to respond to requests for fund transfers by performing currency conversion using the currency conversion rates, by entering corresponding records in the user and FX transaction database, by submitting transactions to the transfer engine, and by causing status emails to be sent to customers;
an transfer engine, comprising:
a transfer processor;
a transfer database;
wherein the transfer processor is adapted to perform on-line payment systems interface processing, batch payment system interface processing, and exception processing;
a risk management module, adapted to use the risk parameters to impose velocity limits on requests for fund transfers.

21. The system of claim 20, wherein the transfers are performed via the ACH network.

22. The system of claim 20, wherein the transfers are performed via the ATM network.

23. A system for performing push-model fund transfers between comprising a transaction previewer that enables a user to select and input one of the set consisting of a desired amount of currency to be sent and a desired amount of currency to be received, and to then display a complete calculation including each other element of the transaction.

24. The system of claim 23, wherein the currencies can be those of any of a plurality of nationalities, and wherein one element of the transaction that is displayed by the transaction previewer is the exchange rate between a nationality of currency to be sent and a nationality of currency to be received.

25. The system of claim 23, wherein the transaction previewer comprises an Internet website.

26. A system for performing push-model fund transfers between at least one user and at least one payor, the system comprising:
at least one payor interface;
a gateway having at least one gateway account, said gateway being operative:
to receive information identifying a desired fund transfer;
to receive incoming funds via a remote deposit from the payor into said at least one gateway account after receiving said information;
to inform the user that the payor has provided an appropriate amount of funds if said incoming funds received are of an appropriate amount according to said desired fund transfer; and
to send corresponding outgoing funds to the user after receiving said incoming funds.

27. The system of claim 26, wherein said at least one payer interface comprises software adapted to permit the payor to provide said information.

28. The system of claim 27, wherein said at least one payer interface further comprises a transaction previewer that enables a user to select and input one of the set consisting of a desired amount of currency to be sent and a desired amount of currency to be received, and to then display a complete calculation including each other element of the transaction.

29. The system of claim 26, wherein the funds can be currencies of any of a plurality of nationalities.

30. The system of claim 29, wherein the currencies can be of any of a plurality of nationalities, and one element of the transaction that is displayed by the transaction previewer is the exchange rate between a nationality of currency to be sent and a nationality of currency to be received.
